(19) United States
(12) Patent Application Publication
(10) Pub. No.: US 2004/0201754 A1
(43) Pub. Date: Oct. 14, 2004

(54) Dual camera mounting arrangement for a wide screen imaging system

(76) Inventor: Micheal J. McAlister, Los Angeles, CA (US)

Correspondence Address: Thomas H. Close, Patent Legal Staff, Eastman Kodak Company, 343 State Street, Rochester, NY, 14650-2201, US

(21) Appl. No.: 09/976,548

(22) Filed: Oct. 12, 2001

(51) Int. Cl. H04N 5/225

(52) U.S. Cl. 348/239

(57) ABSTRACT

A dual camera arrangement for capturing a wide field image of a scene, composed of left and right overlapping fields of view, includes a first camera having an optical section imaging the right field of view along its optical axis onto a first image sensor and a second camera having an optical section imaging a left field of view along its optical axis onto a second image sensor. A camera mount supports the first camera at an angle adjacent to the second camera such that their optical axes intersect between the camera mount and the captured scene whereby the left side of the right field of view overlaps the right side of the left field of view. This creates an overlap region where the left and right fields of view obtained from the respective image sensors may be combined to form the wide field view of the scene.

### FIELD OF THE INVENTION

The invention relates generally to the field of motion picture photography, and in particular to an imaging system for capturing a high resolution, wide field image from a plurality of smaller images.

### BACKGROUND OF THE INVENTION

In producing motion pictures, there is sometimes a need to provide non-traditional camera systems to capture motion picture images from unconventional positions or locations. For instance, it is sometimes desired to strap a small camera system onto a body part, such as on an arm near the boxing glove of a boxer, in order to get better or unusual pictures of the action. In such situations, the cameras must be very small and lightweight. Besides ruling out conventional 35 mm film cameras because of their size and weight, it is usually difficult to obtain widescreen resolution from the sort of video cameras that could be used in this configuration; consequently, it would be desirable to combine several of these cameras in a special rig and then stitch their output pictures together.

There exists a number of arrangements for combining multiple photographs or digital images of a particular scene into a single seamless wide angle panoramic photographic or digital image. One of such known systems is Apple Corporation's Quick Time VR, which can be used to generate a panorama from multiple images taken as a camera is rotated around its nodal point (i.e., the optical center) of the lens, and wherein the frames of the photos overlap slightly.

Software called a “stitcher” automatically joins the individual photos together to make a seamless 360 (or less) degree view. Such a system, however, is unable to capture moving action since only one camera is involved in capturing the separate images.

U.S. Pat. No. 5,657,073 discloses an imaging system which is arranged to produce a panoramic or panospheric output image in either a still or a video format, by seamlessly merging a plurality of simultaneous, overlapping input images which collectively encompass an entire field of view. The system includes a plurality of cameras which direct multiple simultaneous streams of analog or digital input into an image transformation engine, which removes distortion and redundant information, thereby creating a single output image.

While such a system may produce acceptable panoramic or panospheric images, particularly panoramic or panospheric still images, there is a considerable drawback in that the large angular separation of the overlapping fields of view creates considerable distortion across the overlap area. For example, in the '073 patent, the optical axes of the cameras diverge from each other at a 90 degree angle. While this may be tolerable in the case of a still image, it produces a substantial artifact across the overlap area in the case of motion images that are stitched in this area. Moreover, the rig necessary for supporting such cameras tends to large and bulky, just the opposite of what is needed for the special kinds of shots that are contemplated.

What is needed is an arrangement for mounting a pair of small cameras in such a manner that distortion at the overlap region is minimized, while the size of the rig is compact enough for the shots contemplated.

### SUMMARY OF THE INVENTION

The present invention is directed to overcoming one or more of the problems set forth above. Briefly summarized, according to one aspect of the present invention, a camera arrangement for capturing a wide field image of a scene, composed of left and right overlapping fields of view, includes a first camera having an optical section imaging the right field of view along its optical axis onto a first image sensor and a second camera having an optical section imaging a left field of view along its optical axis onto a second image sensor. A camera mount supports the first camera at an angle adjacent to the second camera such that their optical axes intersect between the camera mount and the captured scene whereby the left side of the right field of view overlaps the right side of the left field of view. This creates an overlap region where the left and right fields of view obtained from the respective image sensors may be combined to form the wide field view of the scene.

The advantage of the invention is that the cameras are supported at a relatively small angle relative to each other such that their lenses nearly touch and their optical axes intersect just forward of the front end of the camera mount, which minimizes distortion in the overlapping area of the two fields of view stemming from disparate perspective due to spatial separation of the two camera lenses.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is an illustration of a dual camera mounting arrangement according to the invention.

FIG. 2 is a plan view of the camera mount shown in FIG. 1.

FIG. 3 is a cross-sectional view taken along the line 3-3 of the camera mount shown in FIG. 1.

FIG. 4 is a cross-sectional view taken along the line 4-4 of the camera mount shown in FIG. 1.

FIGS. 5A and 5B are schematic drawings of the interleaved fields of view from the two cameras shown in FIG. 1, showing the overlapping region between them.

FIG. 6 is a drawing of the combined field of view from the two cameras shown in FIG. 1.

FIG. 7 is a block diagram of the system architecture for a film image recording system utilizing video signals generated by the dual camera mounting arrangement shown in FIG. 1.

### DETAILED DESCRIPTION OF THE INVENTION

Because cameras employing electronic sensors are well known, as well as the use of several such cameras to provide images that are subsequently stitched to form a wide field image, the present description will be directed in particular to elements forming part of, or cooperating more directly with, the particular dual camera arrangement that is described herein in accordance with the present invention. Elements not specifically shown or described herein, including any of the well-known stitching algorithms that may be employed to combine two or more overlapping images, may be selected from those known in the art.

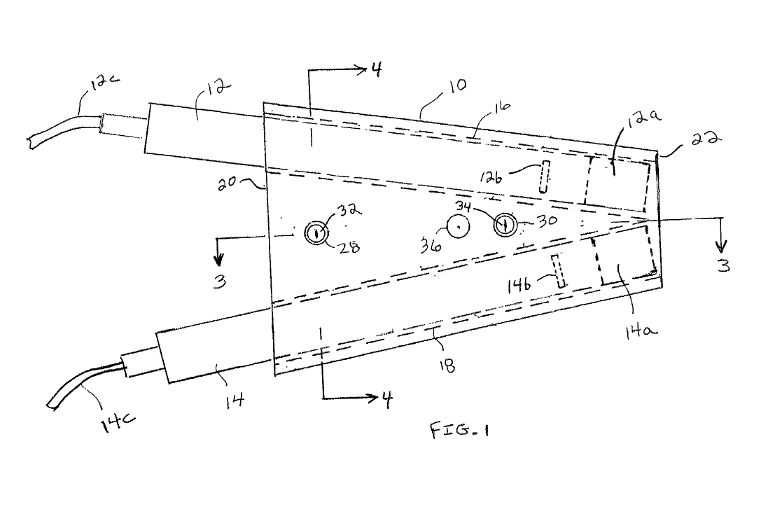

Beginning with FIGS. 1 through 4, the dual camera mounting arrangement includes a camera mount 10 for supporting a pair of small cylindrical cameras 12 and 14, sometimes referred to in the trade as micro-cameras or “lipstick” cameras. (Such cameras are available from Elmo Co., Ltd. of Nagoya, Japan, and generate broadcast quality video from a very small cylindrical package, e.g., 12-17 mm in diameter and 60-75 mm in length. Their sensors are typically ¼ inch or 1/3 inch interline-transfer video resolution charge-coupled device (CCD) sensors.) As shown in FIG. 1, each camera 12 and 14 includes a lens section 12a and 14a that forms respective images on image sensors 12b and 14b that are converted into electronic signals and transmitted to other electronic stages (which will be subsequently described) over the respective cables 12c and 14c.

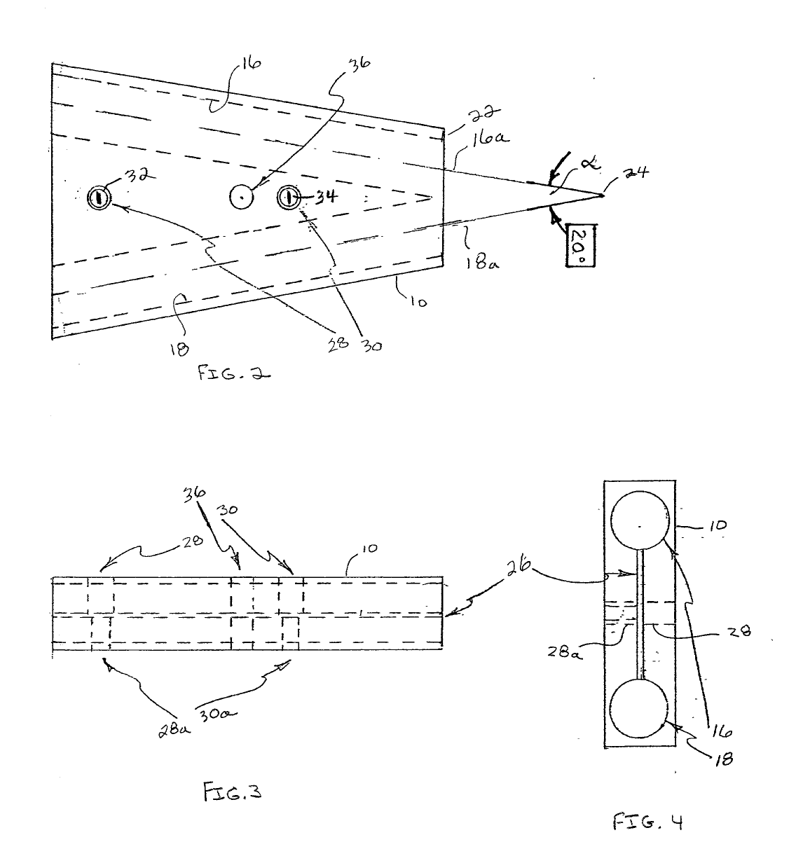

A pair of longitudinal bore holes 16 and 18 extend completely through the camera mount 10 from its wide end 20 to its narrow end 22. The bore holes 16 and 18 have respective bore axes 16a and 18a that converge at an angle α and intersect at a point 24 just forward of the narrow end 22 of the camera mount 10 (as best shown in FIG. 2). A compression slot 26 is formed in the angular space between the bore holes 16 and 18 (as best shown in FIGS. 3 and 4); the slot 26 opens into the bore holes 16 and 18 so as to allow for a small compression in the diameter of the bore holes. Two half-tapped cinch holes 28 and 30 are drilled through the camera mount 10 in the angular space between the bore holes 16 and 18, with each cinch hole having a threaded section 28a and 30a for receiving cinch screws 32 and 34. A mounting hole 36 is also drilled through the camera mount 10.

The cameras 12 and 14 are inserted into the bore holes 16 and 18 until their lenses 12a and 14a are nearly touching at the narrow end 22 of the camera mount 10. At this stage, the bore holes 16 and 18 provide enough clearance that the cameras 12 and 14 can be easily slipped into the camera mount 10 and then twisted until they are correctly positioned for image capture. The cinch screws 32 and 34 are then tightened, thereby squeezing the compression slot 26 until the cameras 12 and 14 are tightly captured within the bore holes 16 and 18. The entire mounting arrangement is very small; for instance, for an intersection angle α of 20 degrees, the full length of the camera mount is on the order of only 2 inches, with the wide end 20 being about 1.4 inches and the narrow end 22 about 0.7 inches. In operation, the camera mount 10 would be attached via the mounting hole 36 to a supporting object, such as an arm bracelet or belt on the arm or body of an actor or photographer.

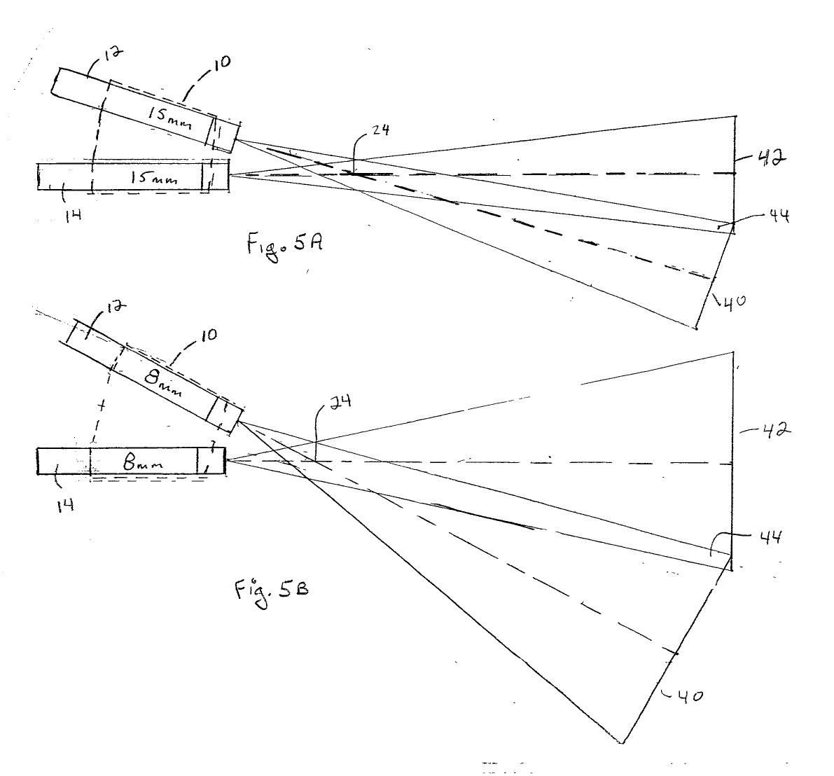

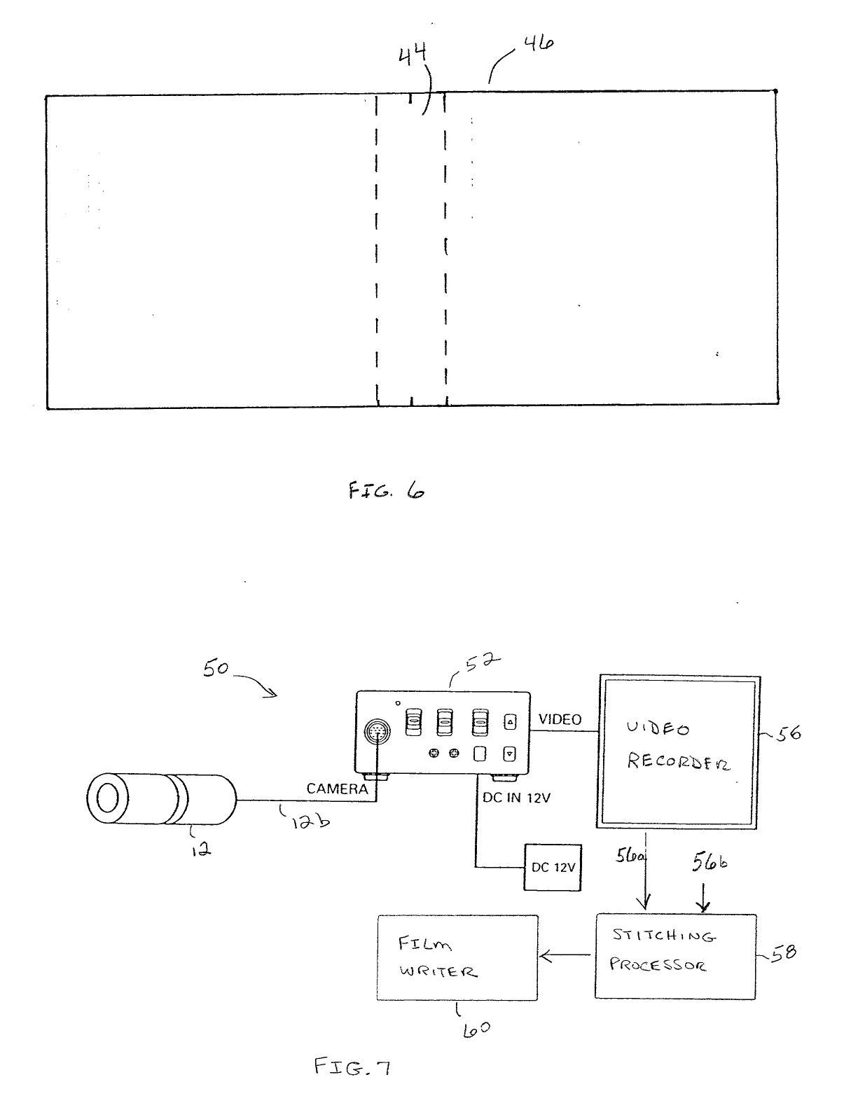

As shown in FIGS. 5A, 5B and 6, the cameras 12 and 14 are mounted in the camera mount 10 (shown in broken line in FIGS. 5A and 5B) at such an angle α that their fields of view 40 and 42 overlap in an overlap region 44 of the combined field of view 46, as best shown in FIG. 6. It is useful in describing the invention to adopt a left and right nomenclature for referring to the two cameras 12 and 14 and the two fields of view 40 and 42 in relation to the combined field of view 46. Accordingly, because of the intersection angle α between the cameras, the field of view 40 is projected into the (left) camera 12 as a right field of view, and the field of view 42 is projected into the (right) camera 14 as a left field of view. Therefore, as can be appreciated from FIGS. 5A and 5B, the camera mount 10 supports the first (left) camera 12 at the angle α adjacent to the second (right) camera 14 such that their optical axes (which are substantially coincident with the bore axes 16a and 18a) intersect between the camera mount 10 and the captured scene represented by the wide field of view 46. This arrangement thus causes the left side of the right field of view 40 to overlap the right side of the left field of view 42, thereby creating the overlap region 44 where the left and right fields of view obtained from the respective image sensors may be combined to form the wide field view 46 of the scene.

The actual cameras used may be selected without particular limitation, except perhaps for considerations of size and sufficient resolution to obtain the needed wide field image. As an example, the particular lipstick cameras used each provided a video resolution of about 752×582 pixels. They were then arranged in the camera mount 10 to produce approximately a 10% overlap in the overlap region 44, which approximately doubled the linear resolution of the combined field of view 46 (e.g., about 1368×582 pixels). However, the intersection angle α may be chosen without limitation, depending on the focal length of the lenses used, to obtain the desired amount of overlap. In FIG. 5A, the lens sections 12a and 14a of the two cameras 12 and 14 have focal lengths of 15 mm, and their optical axes are positioned at a preferred intersection angle α of 20 degrees to obtain approximately a 10% overlap. In FIG. 5B, the lens sections 12a and 14a of the two cameras 12 and 14 have focal lengths of 8 mm, and their optical axes are positioned at a preferred intersection angle α of 36 degrees to likewise obtain approximately a 10% overlap. (The 10% overlap, however, is not to be taken as a limitation; it appears to be optimum for a 2:35 aspect ratio image. Other overlap percentages might be advantageous for other aspect ratios, e.g., for a 1:85 aspect ratio.)

In order to minimize any distortion that might be created in the overlapping area 44 during the stitching process, the cameras 12 and 14 are supported at an angle α relative to each other such that their lens sections 12a and 14a are canted toward each other, even to the point of nearly touching, and their optical axes intersect between the narrow end 22 of the camera mount and the scene being imaged as the wide field image. As mentioned above, this causes the first (left) camera 12 to capture the right view and the second (right) camera 14 to capture the left view with the area 44 of overlap therebetween. The relatively small distance between the lenses of the cameras provides a more nearly coherent perspective between the fields of view and minimizes the distortion that would otherwise appear in the overlap region 44.

Referring now to FIG. 7, a film image recording system 50 is shown that utilizes the images generated by the dual camera arrangement shown in FIG. 1. The block diagram of the system architecture is shown for one of the cameras, e.g. camera 12, but it should be understood that the same system architecture would be repeated for the other camera 14. The camera 12 is connected by its cable 12b to a camera input on a camera control unit 52, which in the preferred embodiment is a Model CC491 camera control unit available from the Elmo Co., Ltd. The camera control unit 52 controls the usual functions of the camera, such as automatic gain control, white balance, electronic shuttering, pedestal level, and so on (for certain adjustments, the camera control unit is connected to a monitor, which is not shown, for screen menu adjustments). The camera control unit outputs a video signal, which is recorded on a video recorder 56. During subsequent postproduction operation, the recorded signal 56a is applied to a digital processor 58; in addition, a recorded signal 56b originating from a camera control unit associated with the other camera 14 is also input to the digital processor 58. The digital processor 58 provides a conventional stitching algorithm for stitching the two images together in their overlapping area. Such stitching algorithms are well-known (an exemplary algorithm is provided by the aforementioned QuickTime VR application) and will not be further described. The stitched image is then output to a film writer 60, which writes the combined image onto a motion picture film, usually a duplicate negative film from which a release print is obtained.

The invention has been described with reference to a preferred embodiment. However, it will be appreciated that variations and modifications can be effected by a person of ordinary skill in the art without departing from the scope of the invention. For example, while a dual camera arrangement is used in the preferred embodiment, there are other situations where more cameras, e.g., three or four cameras, may be employed to capture an even wider field of view. In these situations, each pair of side-by-side cameras can be seen as an instance of the camera arrangement described and claimed in connection with the preferred embodiment.

### Parts List

10 camera mount

12 camera

12a lens section

12b image sensor

12c cable

14 camera

14a lens section

14b image sensor

14c cable

16 bore hole

16a bore axis

18 bore hole

18a bore axis

20 wide end

22 narrow end

24 intersection point

26 compression slot

28 cinch hole

28a threaded section

30 cinch hole

30a threaded section

32 cinch screw

34 cinch screw

36 mounting hole

40 right field of view

42 left field of view

44 overlap region

46 combined field of view

50 film image recording system

52 camera control unit

56 video recorder

56a recorded signal

56b recorded signal

58 digital processor

60 film writer

What is claimed is:

1. A camera arrangement for capturing a wide field image of a scene composed of left and right overlapping fields of views, said camera arrangement comprising:
a first camera having an optical section imaging the right field of view along a first optical axis onto a first image sensor;
a second camera having an optical section imaging a left field of view along a second optical axis onto a second image sensor; and
a camera mount for supporting the first camera at an angle adjacent to the second camera such that their optical axes intersect between the camera mount and the captured scene and the left side of the right field of view overlaps the right side of the left field of view, thereby creating an overlap region where the left and right fields of view obtained from the respective image sensors may be combined to form the wide field view of the scene.

2. The camera arrangement as claimed in claim 1 wherein the angle provided by the camera mount between the first and second cameras is sufficient to cause approximately a 10 percent overlap between the fields of view.

3. The camera arrangement as claimed in claim 1 wherein the cameras each provide a predetermined resolution and the angle provided by the camera mount between the first and second cameras is sufficient to cause approximately a doubling in resolution between the predetermined resolution of the cameras and a resolution of the wide field image.

4. Apparatus for supporting a pair of cameras that capture a wide field image of a scene composed of left and right overlapping fields of views, said apparatus comprising a camera mount for supporting a first camera at an angle adjacent to a second camera such that their optical axes intersect between the camera mount and the captured scene whereby the left side of the right field of view overlaps the right side of the left field of view.

5. The apparatus as claimed in claim 4 wherein the angle provided by the camera mount between the first and second cameras is sufficient to cause approximately a 10 percent overlap between the fields of view.

6. A film image recording system for capturing a wide field image of a scene composed of left and right overlapping fields of views, said film image recording system comprising:
a first video camera having an optical section imaging the right field of view along a first optical axis onto a first image sensor;
a second video camera having an optical section imaging a left field of view along a second optical axis onto a second image sensor; and
means for supporting the first camera at an angle adjacent to the second camera such that their optical axes intersect between the camera mount and the captured scene and the left side of the right field of view overlaps the right side of the left field of view, thereby creating an overlap region where the left and right fields of view obtained from the respective image sensors may be combined to form the wide field view of the scene;
a digital processor including an algorithm for stitching the left and right fields of view together in the overlap region, there providing a wide screen image; and
a film writer for writing the wide screen image onto a photographic film element.

7. The system as claimed in claim 6 wherein the angle provided by the camera supporting means between the first and second cameras is sufficient to cause approximately a 10 percent overlap between the fields of view.

8. The system as claimed in claim 6 wherein the cameras each provide a predetermined resolution and the angle provided between the first and second cameras is sufficient to cause approximately a doubling in resolution between the predetermined resolution of the cameras and a resolution of the wide screen image.
